(19) United States
(12) Patent Application Publication
(10) Pub. No.: US 2012/0198657 A1
(43) Pub. Date: Aug. 9, 2012

(54) Pivot Sliding Hinge

(75) Inventors: Ken Ming Lai, San Francisco, CA (US); Dan Ray Marshall, Winchester, CA (US)

(73) Assignee: Great Bay Trading, Inc., San Francisco, CA (US)

(21) Appl. No.: 13/020,017

(22) Filed: Feb. 3, 2011

(51) Int. Cl. E05D 3/10

(52) U.S. Cl. 16/367

(57) ABSTRACT

A telescoping adjustable pivot sliding hinge system, for mounting a door with at least a portion of the side edge of the door projecting into the opening when the door is in an open position, is disclosed. An upper mounting plate is mounted onto the door's top edge and is fastened to the door's interior side. First and second guide tracks are installed onto the header of the door opening. The upper mounting plate includes a pair of guide members that are operatively moveably engaged respectively with the first and second guide tracks. A lower mounting plate is mounted on a lower horizontal surface of the door opening, and includes a lower guide track and a telescoping adjustable pivot arm that is horizontally and rotationally captured at a proximal end thereof by the lower mounting plate. The lower mounting plate can be adjusted in relation to the base plate, and can be locked permanently with the said base plate by two machine screws and two nuts. The pivot arm's distal end is attached onto the door's bottom edge. A lower guide member, which is tucked into a guide shield, is fixed onto the door's bottom edge, and is operatively movably engaged with the lower guide track.

### REFERENCES CITED

### United States Patents

| | | | |
|---|---|---|---|
| 5,369,912 | December 1994 | Ginzel, et al. | 49/141 |
| 4,897,962 | February 1990 | Itoh; Mituru | 49/208 |
| 4,306,377 | December 1981 | Sterling, et al. | 49/250 |
| 4,302,865 | December 1981 | Dixon, et al. | 16/97 |
| 1,960,496 | May 1934 | Kelly | 49/260 |
| 1,604,368 | October 1926 | Smith | 49/260 |
| 1,448,845 | March 1923 | Johnson, et al. | 49/260 |

### BACKGROUND OF THE INVENTION

This invention presents a door-hinge assembly with a telescoping adjustable pivot arm and a fixed base, and more particularly to a door hinge system for mounting a door in a door opening.

It is known that doorways must be kept clear of objects in order to provide room for the door to open fully. Yet keeping such doorways clear, particularly in small or crowded rooms, can be difficult. If an object blocks such a doorway, the door is prevented from opening fully. This problem is particularly evident with pivoting closet doors, since often small bedrooms are packed with furniture.

Prior arts include a variety of door hinge systems which have been designed to hang doors. These door hinge systems of prior arts can be classified generally into two categories: fixed door-hinge system and pivotable, movable door-hinge system.

In the first category, the fixed door-hinge system commonly have mortised hinges that are fixed in positions on the door jambs, which confine a door's movement in swinging path. These hinges tend to be singular units, with no adjustment functions. A typical example is the “butt” hinge. This door hinge system lacks a mechanism of pivoting adjustment. It has no track for guiding the door's movement in an opening. Furthermore, this door hinge system requires clearance of any hindering object, in the path of swinging movement.

In the second category, a door-hinge system may consist of a pivoting hinge and a top track which guides the movement of the pivot hinge. Examples of this second category include the prior arts such as U.S. Pat. No. 5,369,912, U.S. Pat. No. 4,306,377, and U.S. Pat. No. 1,604,368. Door-hinge systems of these prior arts have a guide track and a pivoting guide at the bottom engaging a bottom track. However, these door-hinge systems do not have a telescoping adjustable pivot arm for ensuring proper adjustment so that the door opening can be aligned with the sub-floor, and for ensuring that the door is squared in the door opening. Furthermore, these prior-arts lack a unitary part as presented in this invention which can make installation much easier. Moreover these units require a clearance of any objects in the path of its swinging.

Therefore, there is a need for a device that will cause the least part of the door to extend into the doorway opening when the door is in the open position, thereby requiring less open space in front of the doorway. Such a needed device would include a minimal number of parts, keeping installation of such a device relatively easy and inexpensive. The present invention accomplishes these objectives.

### SUMMARY OF THE INVENTION

The present invention is a door-mounting system for mounting a door in a door opening. An upper mounting plate is configured for mounting on top edge of a door, and it slides along a first guide track and a second guide track. The first guide track runs across the top opening, usually directly under and in the center of the wooden header. The first guide track has a notched portion to receive a second guide track in a 10-degree angle.

The upper mounting plate includes a pair of guide members that are operatively moveably engaged with the first and second guide tracks of the upper mounting plate. A track cover is provided, so that it can be snapped onto the first guide track at the position where the cover does not interfere with the said guide members' movement.

A lower mounting plate is configured for mounting on a lower horizontal surface of the door opening and includes a lower guide track and a telescoping adjustable pivot arm that is horizontally and rotationally captured at a proximal end thereof by the lower mounting plate. The lower mounting plate has two elongated slots for any lateral adjustment with a base plate. The base plate provide three holes so that machine screws and their respective nuts can be used to lock the base plate with the lower mounting plate, and with the lower guide track. A distal end of the telescoping adjustable pivot arm is configured for attaching with a lower edge of the door. A lower guide member is tucked into a guide shield which is drilled into the door's bottom edge, and generally adjacent to the side edge of the door. The lower guide member is operatively movably engaged with the lower guide track of the lower mounting plate. The door may be moved between an open position and a closed position. At least a portion of the side edge of the door projects into the opening when the door is in the open position.

The present invention is a system for mounting a door into a doorway such that at least part of the door extends into the doorway opening when the door is in the open position, thereby requiring less open space in front of the doorway. The present device includes a minimal number of loose parts when it is fully assembled at factory, keeping installation of this pivot sliding hinge relatively easy and inexpensive. Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a perspective view of this pivot-sliding-hinge invention, which is installed on a single, right-handed door in a door opening.

FIG. 2 is an exploded, perspective view of the right-handed, pivot-sliding-hinge invention, showing all the components before they are assembled.

FIG. 3 is a top view of the lower mounting plate of the pivot-sliding-hinge invention configured for a right-handed door.

FIG. 4 is a perspective view of the top mounting bracket, showing the paired guide members and their respective nylon washers, before they are assembled.

FIG. 5 shows detailed views of the telescoping, adjustable pivot arm with female screw-threads tapped into a portion of the pivot arm, and of the promxial end.

FIG. 6 is a perspective view of the first-guide track intersecting the second-guide track, at a 10-degree angle, the track cover, and the top mounting plate, in relation to the door opening.

FIG. 7 is the cross-sectional view of the first-guide track and top-mounting plate assembly in relation to the door.

FIG. 8 is a plan view diagram of the upper mounting plate, illustrating respectively the door's open position and the door's closed position.

FIG. 9 is plan view diagram of the lower mounting plate, illustrating respectively the door's open position and the door's closed position.

FIG. 10 is a plan view diagram of the upper and lower mounting assemblies of FIGS. 8 and 9 superimposed, illustrating the two door positions wherein a lower guide track is adjusted to align with a first guide track of the upper mounting plate.

### DETAILED DESCRIPTION OF THE INVENTION

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

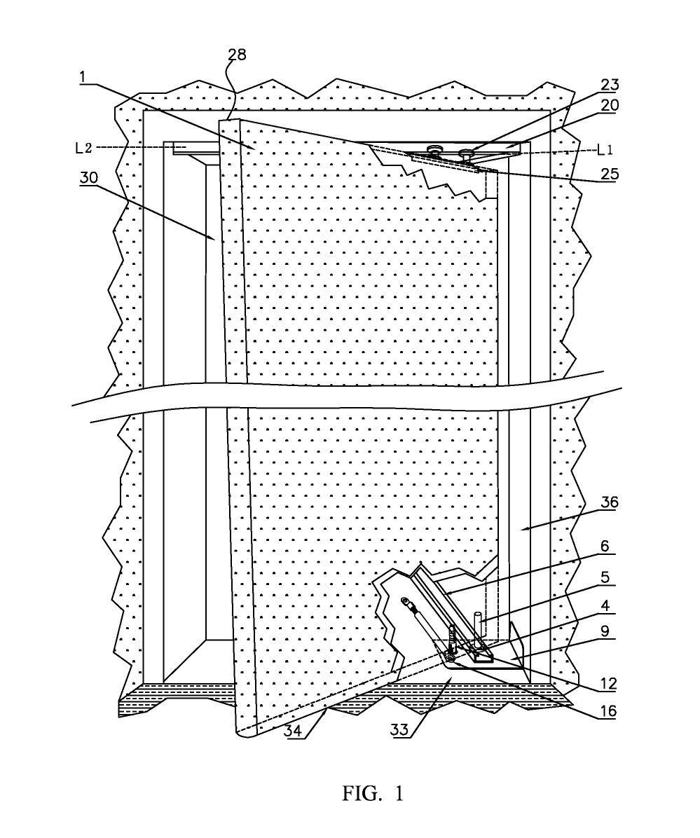

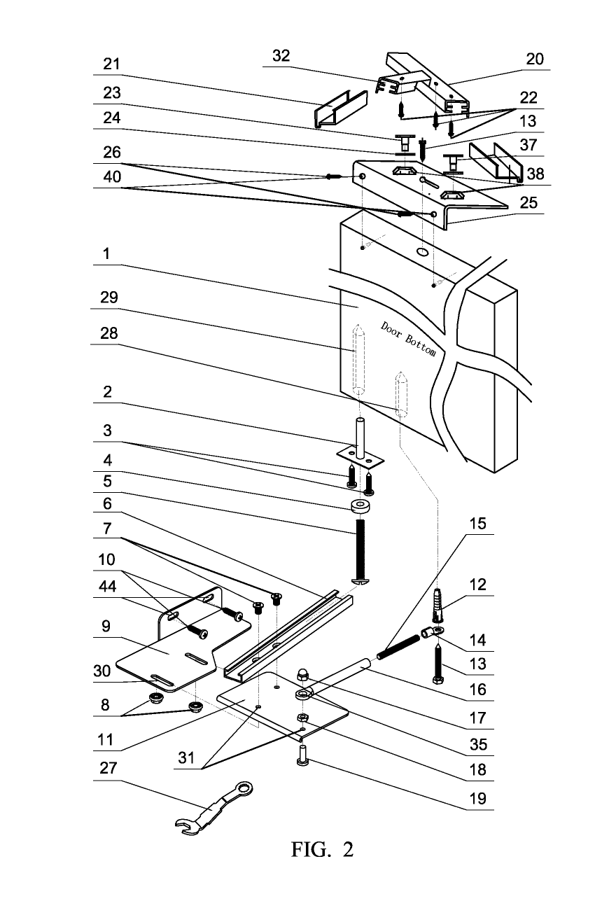

FIG. 1 illustrates a door-mounting system for mounting a door 1 in a door opening 30. Referring to FIG. 2, a rigid upper mounting plate 25 is configured for mounting on the upper surface of the door opening 30 and includes a first guide track 20 and a second guide track 32. Referring to FIG. 6, the first guide track 20, and the second guide track 32 have mutually intersecting longitudinal axes L₂ and L₁, respectively at an approximately 10-degree angle. As indicated in FIG. 6, the first guide track has a notched area to received the second guide track. In FIG. 1, the first guide track 20 is mounted at the bottom of the header across the entire opening 30 by the Phillips wood screws 22. The second guide track 32 is mounted onto the bottom of the header by the same Phillips wood screw 22. The first guide track 20 and the second guide track 32 are made of extruded aluminum. As illustrated in FIG. 6, a track cover 21 has two legs each with a curved end. The two legs are slightly bending inside toward the cover's center. This track cover 21 is snapped onto the first guide track 20, by having the track cover's two legs curved ends touching the upper, round corners of the first guide track 20. The track cover 21 is made from extruded aluminum.

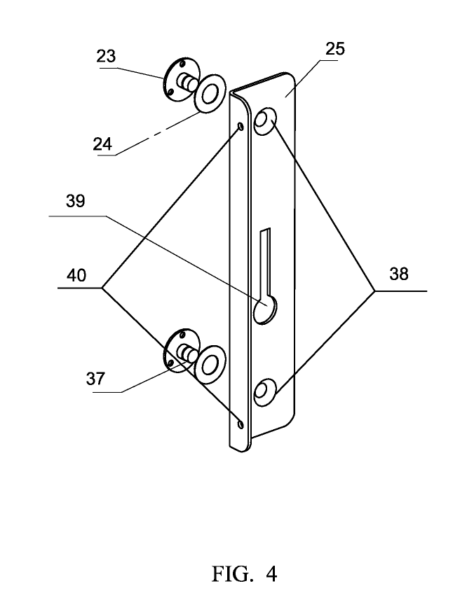

As indicated in FIG. 4, the upper mounting plate 25 is preferably made from a strong metal material, bent at a 90-degree angle, milled and drilled to specifications. At the bottom of the mounting plate 25 are two holes with countersinks 38, which receive the riveted portion 37 of the two guide members 23. The mounting plate 25 has an elongated slot ending with a circular hole 39. This elongated slot 39 receives the hex-headed wood screw 13 which fastens the mounting plate 25 onto the door's top edge. As shown in FIG. 6, the narrow and straight part of the elongated slot 39 in the upper mounting plate allows the hex-headed wood screw 13 to slide into position. As the hex-headed screw 13 is slided back or forth, the door's position can be adjusted, to be flushed with the door jamb 36, and or to be squared with the door opening 30. After adjustment of the door 1 is made, the hex-headed screw 13 can be tightened by the use of a wrench 27 to set the door into a permanent position. Through the two holes 40 on the mounting plate 25, two Phillips pan headed screws 26 fasten the mounting bracket 25 onto the upper edge of the door's interior side 28.

The upper mounting plate 25 includes a pair of guide members 23 that are operatively moveably engaged with respectively the first guide track 20 and second guide track 32. Each guide member 23 includes a rotatable wheel slidably and rotatably capturable within respectively the guide tracks 20,32. Each guide member has a nylon washer 24 that is in contact with the first guide track inner walls 20. A second guide member also has the same nylon washer 24 that is in contact with the second guide track 32. These washers 24 help reduce the guide members' friction with the first guide track 20 and the second guide track 32, as the said guide members sliding across their respective guide tracks 20, 32. As indicated in FIG. 4, the guide members' lower part 37 are riveted onto the countersunk holes 38 on the mounting bracket.

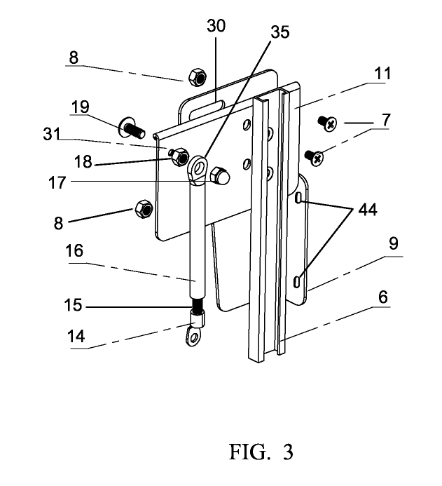

As shown in FIG. 3, a lower mounting plate 9 is configured for mounting on a lower horizontal surface 33 of the door opening 30. The lower mounting plate 9 is preferably made from a strong metal material. This lower mounting plate includes a lower guide track 6 and a telescoping adjustable pivot arm 16 that is horizontally and rotationally captured at a proximal end 35 thereof by the base plate 11. A machine screw 19 going through the screw-hole 31 and through a hex nut 8 is mated with a cap nut 17, to lock the proximal end 35 with the base plate 11. The lower mounting plate 9 is installed onto the door-jamb 36 by two Phillips wood screws 10 going through the mounting plate's two oval screwholes 44, as shown in FIG. 1. A distal end 14 of the telescoping adjustable pivot arm 16 is configured for attaching with the bottom edge 34 of the door 1 by means of a Phillips wood screw 13 going through the distal end's center hole 14 into a molly 12 provided which has already been inserted into the door-bottom's pre-drilled screw-hole 28.

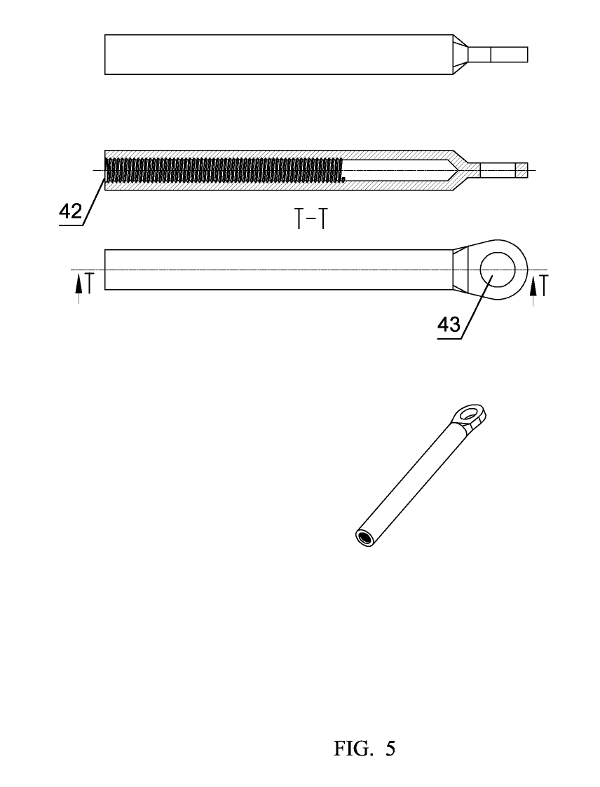

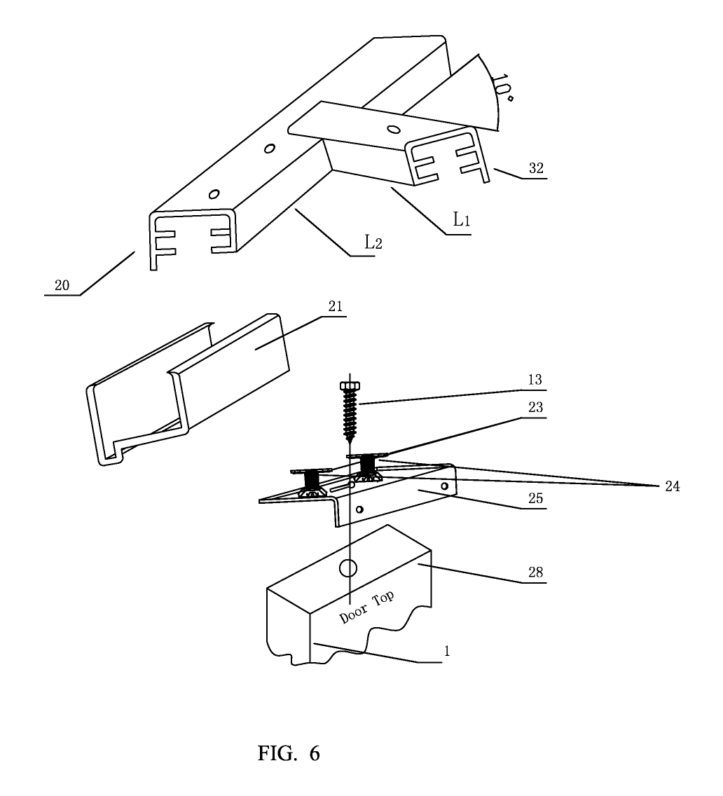

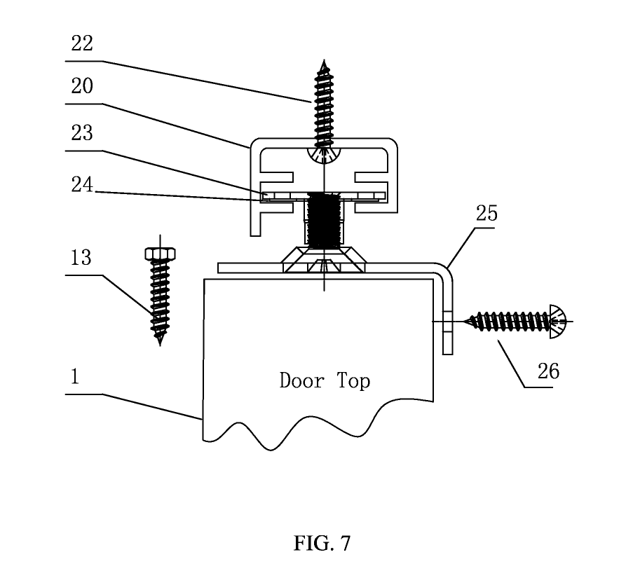

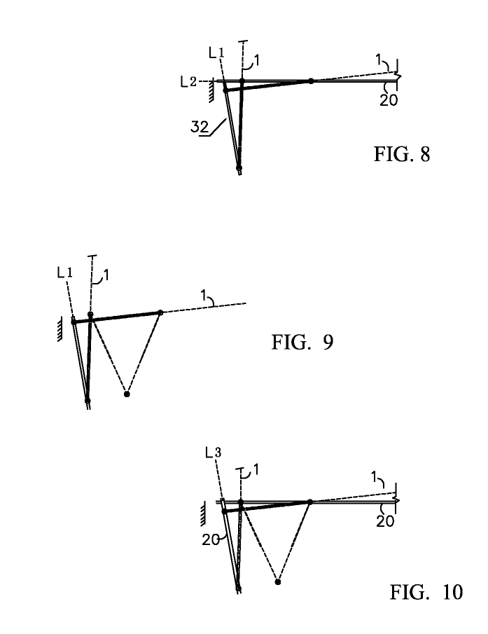

The telescoping adjustable pivot arm 16 is made of a cylindrical aluminum rod. At one end of the pivot arm is the proximal end 35. The proximal end 35 is tapered as indicated in FIG. 5. The promixal end has a hole for receiving a machine screw 19. The machine screw 19 and its cap 17 connect the proximal end 35 of telescoping pivot arm 16 to the base plate 11, by going through the hole of the proximal end 35 of the pivot arm 16. Directly underneath the proximal end 35 of the telescope pivot arm is a hex nut 18 which prevents proximal end from rubbing against the base plate 11. After the cap 17 is threaded fully onto the machine screw 19, there is a sufficient space allowed between the proximal end 35 and the hex nut 18 directly underneath. This extra space allows the pivot arm to move freely and to be adjusted in any angle as the pivot arm's distal end 14 is being mounted into the molly 12 by the Phillips wood screw 13 onto the door's bottom edge.

The pivot arm's other end, which is opposite to the proximal end 35, is tapped with female screw-threads in the center, as shown in FIG. 5. A shaft 15 is threaded with male screw-threads. This shaft's male threads mate with the female threads of the pivot arm 16, by means of rotation of the shaft 15. This rotational movement provides the telescoping adjustment to the overall length of the pivot arm 16. The shaft's other end is connected with the distal end 14. The pivot arm 16 and the shaft 15 can be made from extruded aluminum rod.

The lower mounting plate 9 is supported by the base plate 11, which have three holes 31. The first two holes 31 are for receiving two machine screws 7 that fasten the lower guide track 6 to the base plate, and the third hole for receiving another machine screw 19 that connects the base plate 11 to the lower mounting plate 9 with the promixal end 35 of the adjustable telescoping pivot arm 16. The base plate has a portion being bent 180-degree toward its back, allowing ⅛″ space in between. This ⅛″ space is for the lower mounting plate 9, to be slidunderneath the base plate 11. When the lower mounting plate 9 is slid underneath the base plate 11, and is flushed on inner edge with the base plate, the elongated slot 30 of the lower mounting plate 9 is aligned and directly underneath the hole 31 of the base plate 11. This elongated slot 30 allows lateral adjustment of the lower mounting plate 9 in relation to the base plate 11. This lateral adjustment gives this door-hinge system the capability to adjust the door 1 to be squared, and to be flushed with the sub-floor below. A second elongated slot 30 of the lower mounting plate 9 is provided for adjustment of the lower guide track 6. To lock the lower guide track 6 onto the lower mounting plate 9, two nuts 8 are mated with the machine screws 7 through the screw-holes 30 of the base plate 11, and through the elongated slot 30 of the lower mounting plate 9. Referring to FIG. 1 and FIG. 2, two Phillips pan-headed screws 10 fasten the lower mounting plate 9 throught another two oval holes 44 onto the door jamb 36. The base plate 11 can be made of strong metal material.

Referring to FIG. 2, a lower guide member 5 is a long machine screw. It is to be tucked into a guide shield 2. Two Phillips wood screws 3 fasten the guide shield 2 into the door's bottom pre-drilled hole 29. The guide shield 2 is made of sheet metal and metal tubing. It has two countersunk screw-holes to received the two Phillips wood screws 3. The lower guide member 5 is operatively movably engaged with the lower guide track 6 of the lower mounting plate 9. The lower guide track is made of extruded aluminum. The press-fitted nylon washer 4 on the lower guide member 5 limits the up-or-down movement of the said lower guide member 5 in relation to the lower guide track 6, and ensures the said lower guide member 5 to slide perpendicularly along the said lower guide track 6. The lower guide track 6 defines a longitudinal axis L₃ that is preferably substantially coplanar to the longitudinal axis L₁ of the second guide track 32 of the upper mounting plate 25 when the upper mounting plate 25 is mounted in the opening 30.

As shown in FIG. 6, the hex-headed wood screw 13 fastens the upper mounting plate 25 onto the top edge 28 of the door 1. Two Phillips pan-headed screws 26 fasten the mounting plate on the interior side at the upper edge of the door 1. The two guide members 23 of the upper mounting plate 25 are slidably engaged respectively with the first guide track 20 and the second guide track 32. Referring to FIG. 4, the upper mounting plate 25 have two counter-sunk screw-holes 38, which allow the bottom portion 37 of the guide members to be riveted onto the countersinks 38. The upper mounting plate 25 has an elongated slot ending with a circular opening 39. This elongated slot 39 gives room for door adjustment when the hex-headed screw 13 is initially screwed onto the top edge of the door 1, before the hex-headed screw 13 is fully tightened. The door 1 can be moved back and forward along the first guide track 20, so that the installer can flush the door 1 with the door jamb 36 and to ensure that the door is squared with the opening 30.

What we claim is:

1. A door-mounting system for mounting a door in a door opening, comprising:
a first and a second guide tracks, each track having mutually intersecting longitudinal axes at the notched portion of the first guide track;
a track cover wherein legs are bending inward with curved ends, to be snapped onto the first guide track;
an upper mounting plate configured for mounting generally at the upper edge of the door and generally adjacent to a door jamb, the upper mounting plate including a pair of guide members each being operatively movably engaged with a respective one of the first and second guide tracks of the upper mounting plate, and with the said pair of guide members being rivted to the countersunk screw-holes of the said upper mounting plate;
a lower mounting plate configured for mounting on a lower horizontal surface of the opening and including a lower guide track and a telescoping adjustable pivot arm horizontally and rotationally captured at a proximal end thereof by the lower mounting plate, a distal end of the pivot arm configured for attaching to the bottom edge of the door;
the said lower mounting plate has two elongated slots for making adjustment relative to the lower guide track, and for making adjustment relative to the base plate;
a based plate with three holes, with first two holes to receive the machine screws that fasten the lower guide track and the lower mounting plate to the base plate, with the third hole to receive another machine screw to lock the promixal end of the pivot arm;
a lower guide member to be inserted into a guide shield that is fixed with the bottom edge of the door, the lower guide member being operatively movably engaged with the lower guide track of the lower mounting plate;
a telescoping, adjustable pivot arm with female screw-threads mating with the male-screw thread of a shaft, with the said shaft connecting a distal end that is fastened by a wood screw going through the said adjustable pivot arm's distal end into a molly already inserted into the door bottom;
whereby with the first guide track mounted on the header of the door opening and the upper mounting plate mounted at the door's top edge, two guide members slidably engaged with respectively the two tracks; and with the lower guide member engaged with the lower track, the lower mounting plate fixed onto the door jamb, and the distal end of the pivot arm fixed to the door's bottom edge, the door may be moved between an open position and a closed position, at least a portion of the side edge of the door projecting into the opening when the door is in the open position.

2. The door-mounting system of claim 1 wherein the longitudinal axis of the second guide track and the longitudinal axis of the lower guide track are substantially coplanar when installed in the door opening.

3. The door-mounting system of claim 1 wherein the first guide track extends across the upper surface of the opening substantially to the same extent as the door when the door is in the closed position.

4. The door-mounting system of claim 1 wherein the upper mounting bracket having an elongated slot ending with a circular opening to receive a hex-headed screw for adjustment and fasteneing; having two holes to received two wood screws to fasten the said upper mouting bracket to the door's interior, upper edge; and having two counter-sunk holes to received the riveted portion of the two guide members.

5. The door-mounting system of claim 1 wherein the lower mounting plate are fastened by two wood screws onto a door jamb, with an adjustable base plate slidably retained on the lower mounting plate, with the adjustable base plate fixed with the proximal end of the pivot arm and the lower guide track, and with the adjustable base plate lockable with respect to the lower mounting plate.

6. The door-mounting system of claim 5 wherein the lower mounting plate includes two elongated holes for receiving a machine screw which locks the adjustable base plate to the lower mounting plate and simultaneously locking one end of the lower guide track, and for receiving a second machine screw which locks the lower guide track to both the lower mounting plate and base plate.

7. The door-mounting system of claim 5 wherein the lower mounting plate and the adjustable base plate each include a plurality of adjustment apertures by means of having two elongated slots on the lower mounting plate; wherein the adjustable base plate is locked onto the lower mounting plate by two machine screws.

8. The door-mounting system of claim 1 wherein two guide members each having a rotatable wheel slidably and rotatably capturable within the first and second guide tracks; wherein the two guide members are riveted onto the two countersunk holes of upper mounting bracket.

9. The door-mounting system of claim 8 wherein two guide members both have nylon washers to reduce the said guide members' friction with the first guide track when the guide members move along the first track.

10. The door-mounting system of claim 1 wherein a lower guide member is provided, with the said lower guide member moves along a lower guide track, and with the lower guide member being tucked into a guide shield; and wherein the guide shield is fastened by two wood screws, into the door's bottom edge.

11. The door-mounting system of claim 1 wherein the lower guide track is fastened to the lower mounting plate by two machine screws going through the lower mounting plate and the base plate, mating with the two nuts below the base plate.

12. The door mounting system of claim 1 wherein the first guide track has a notched portion to receive the second guide track at a 10-degree angle.

13. The door-mounting system of claim 1 wherein the pivot arm is adjustable because the shaft's male screw threads can be mated with the said pivot arm's female screw-threads, and because the shaft can be rotated into or out of the pivot arm, whereby the extent to which the side edge of the door projects into the opening when the door is in the open position may be selectively adjusted.

14. The door-mounting system of claim 1 wherein the telescoping pivot arm's distal end is fastened to a molly which has been inserted into the door's bottom edge, by using a wood screw.
